(19) United States
(12) Patent Application Publication
(10) Pub. No.: US 2026/0189663 A1
(43) Pub. Date: Jul. 2, 2026

(54) IMAGE FORMING APPARATUS

(71) Applicant: BROTHER KOGYO KABUSHIKI KAISHA, Nagoya (JP)

(72) Inventors: Tomoyuki Mizuno, Nagoya (JP); Soma Nagaya, Nagoya (JP); Takato Mori, Nagoya (JP); Koji Akagi, Inazawa (JP); Takahito Yamaji, Nagoya (JP)

(21) Appl. No.: 19/414,427

(22) Filed: Dec. 10, 2025

(30) Foreign Application Priority Data
Dec. 27, 2024 (JP) 2024-232114

(51) Int. Cl. H04N 1/00

(52) U.S. Cl. CPC H04N 1/00559; H04N 1/00411; H04N 1/00543; H04N 1/00551; H04N 1/00557; H04N 1/00907

(57) ABSTRACT

An image forming apparatus includes a panel, a panel circuit board, a first cover, a second cover, and a first fastener. The panel circuit board has a first surface and a second surface on opposite faces of the panel circuit board. The panel is located on the first surface of the panel circuit board. The first cover faces the first surface of the panel circuit board and has a panel opening. The second cover faces the second surface of the panel circuit board. The first fastener fastens the first cover, the panel circuit board, and the second cover together. The first cover includes a hook for holding the panel circuit board.

### REFERENCE TO RELATED APPLICATIONS

This application claims priority from Japanese Patent Application No. 2024-232114 filed on Dec. 27, 2024. The entire contents of the priority application are incorporated herein by reference.

### BACKGROUND ART

An image forming apparatus known in the art includes a main housing, a panel, a panel circuit board, and a cover. The panel is configured to display information related to image forming and to input commands. The panel circuit board is connected to the panel. The cover is attached to the main housing and covers the panel circuit board. The cover can be removed from the main housing in order to replace the panel circuit board.

### SUMMARY

In order to replace the panel circuit board in such an image forming apparatus, a plurality of fasteners such as screws are removed to remove the cover from the main housing, and then fasteners fastening the panel circuit board and the cover are removed to remove the panel circuit board from the cover. Thus, many fasteners have to be removed to replace the panel circuit board, which makes it difficult to easily replace the panel circuit board.

It would be desirable to provide an image forming apparatus that allows the panel circuit board to be easily replaced without removing many fasteners.

In one aspect, an image forming apparatus according to the present disclosure includes a panel, a panel circuit board, a first cover, a second cover, and a first fastener.

The panel circuit board has a first surface and a second surface on opposite faces of the panel circuit board. The panel is located on the first surface. The first cover faces the first surface of the panel circuit board and has a panel opening. The second cover faces the second surface of the panel circuit board. The first fastener fastens the first cover, the panel circuit board, and the second cover together. The first cover includes a hook for holding the panel circuit board.

Since the image forming apparatus includes the first fastener fastening the first cover, the panel circuit board, and the second cover together, the panel circuit board can be easily replaced by removing the first fastener and without removing many fasteners. Further, since the first cover includes a hook for holding the panel circuit board, the panel circuit board will not fall off the first cover even if the first fastener is removed.

The first fastener may fasten the first cover and the second cover from a second-cover side.

Since the first fastener is fastened from the second-cover side, the first fastener will not be easily noticeable from the first-cover side.

The first cover may have a boss protruding toward the second cover and having a hole into which the first fastener is inserted.

The first fastener may be a screw including a threaded portion and a head. The second cover may include a recess into which the head of the first fastener is inserted, and a through hole through which the threaded portion of the first fastener extends and which is located in a position that overlaps the hole of the boss.

Since the head of the first fastener is inserted into the recess, the head of the first fastener can be made less noticeable.

The image forming apparatus may further include a main housing, an image forming unit that forms an image on the sheet, a scanner that scans a document, and a scanner housing forming an external aesthetic surface of the scanner and constituting a part of the main housing. The scanner housing may include the second cover.

The second cover may be integrally formed with the scanner housing and protrude horizontally.

Since the second cover is integrally formed with the scanner housing, the rigidity of the second cover can be ensured.

The image forming apparatus may further include another first fastener. Each of the first fasteners may fasten the first cover, the panel circuit board, and the second cover together.

The image forming apparatus may further include an image forming unit, a main circuit board that controls the image forming unit, and a cable that electrically connects the main circuit board and the panel circuit board. The panel circuit board may further include a connector to which the cable is connected. The connector may be located on the second surface of the panel circuit board.

Since the connector electrically connected to the panel circuit board is located on the surface of the panel circuit board opposite to the surface of the panel circuit board facing the panel, the cable can be easily removed when the panel circuit board is replaced.

The panel circuit board may be connected to the first cover and the second cover by the first fastener without any fastening members.

Since the panel circuit board is connected to the first cover and the second cover by the first fastener without any fastening members, the panel circuit board can be removed if the first fastener is removed.

The image forming apparatus further includes a metal plate located between the panel circuit board and the second cover and fastened by the first fastener together with the panel circuit board and the second cover.

Since the image forming apparatus further includes the metal plate fastened by the first fastener together with the panel circuit board and the second cover, static electricity can be restrained from building up in the panel circuit board and the second cover.

The image forming apparatus may further include a second fastener that fastens the second cover and the panel circuit board and does not fasten the panel circuit board to the first cover.

Since the image forming apparatus further includes a second fastener that fastens the second cover and the panel circuit board and does not fasten the panel circuit board to the first cover, the panel can be replaced while the panel circuit board remains fastened to the second cover by removing the first fastener and not removing the second fastener.

The first fastener and the second fastener may be screws. The second fastener may be shorter than the first fastener.

The image forming apparatus may further include a shaft that rotatably supports the first cover relative to the second cover. The first cover may be rotatable between an open position in which the second surface of the panel circuit board is accessible and a closed position in which the second surface of the panel circuit board is not accessible.

Since the first cover is rotatable to an open position in which the second surface of the panel circuit board is accessible, the panel circuit board can be removed with the first cover in the open position. Further, since the panel circuit board is removed with the first cover in the open position, damage to the panel circuit board can be restrained.

The image forming apparatus may further include a supporting plate supporting the panel, located between the panel and the panel circuit board, and fastened by the first fastener together with the first cover, the panel circuit board, and the second cover.

The panel circuit board may be in contact with the supporting plate.

The image forming apparatus may further include a third fastener that fastens the first cover and the supporting plate and does not fasten the panel circuit board and the second cover to the first cover.

Since the image forming apparatus includes a third fastener that fastens the first cover and the supporting plate and does not fasten the panel circuit board and the second cover to the first cover, only the panel circuit board can be replaced while the supporting plate remains fastened to the first cover by removing the first fastener and not removing the third fastener.

The first fastener and the third fastener may be screws. The third fastener may be shorter than the first fastener.

The panel may include a sensing panel that senses contact, a liquid crystal panel positioned beneath the sensing panel, and a touch panel plate positioned between the sensing panel and the liquid crystal panel. The liquid crystal panel may be located between the touch panel plate and the supporting plate.

The supporting plate may be fastened to the first cover and the second cover by the first fastener without any fastening members.

Since the supporting plate is fastened to the first cover and the second cover by the first fastener without any fastening members, the supporting plate can be removed if the first fastener is removed.

### BRIEF DESCRIPTION OF DRAWINGS

The above aspects, other advantages and further features will become more apparent by describing in detail illustrative, non-limiting embodiments thereof with reference to the accompanying drawings, in which:

FIG. 1 is a cross-sectional view of an image forming apparatus.

FIG. 2 is a perspective view of the image forming apparatus.

FIG. 3 is a perspective view of the image forming apparatus with a document cover of a scanner open.

FIG. 4 is a perspective view showing a state where a first cover is removed from a second cover.

FIG. 5 is a perspective view showing a state where a panel circuit board, a supporting plate, and a panel is removed from the first cover.

FIG. 6 is an exploded perspective view of a touch panel.

FIG. 7 is a cross-sectional view of an operation panel.

FIG. 8 is an exploded cross-sectional view of the operation panel.

FIG. 9 is an exploded cross-sectional view of another operation panel.

FIG. 10 is an exploded cross-sectional view of yet another operation panel.

FIG. 11 is an exploded cross-sectional view of still another operation panel.

FIG. 12A is an illustration showing the first cover in a closed position.

FIG. 12B is an illustration showing the first cover in an open position.

### DESCRIPTION

A first embodiment of the present disclosure will be described in detail referring to the drawings where appropriate.

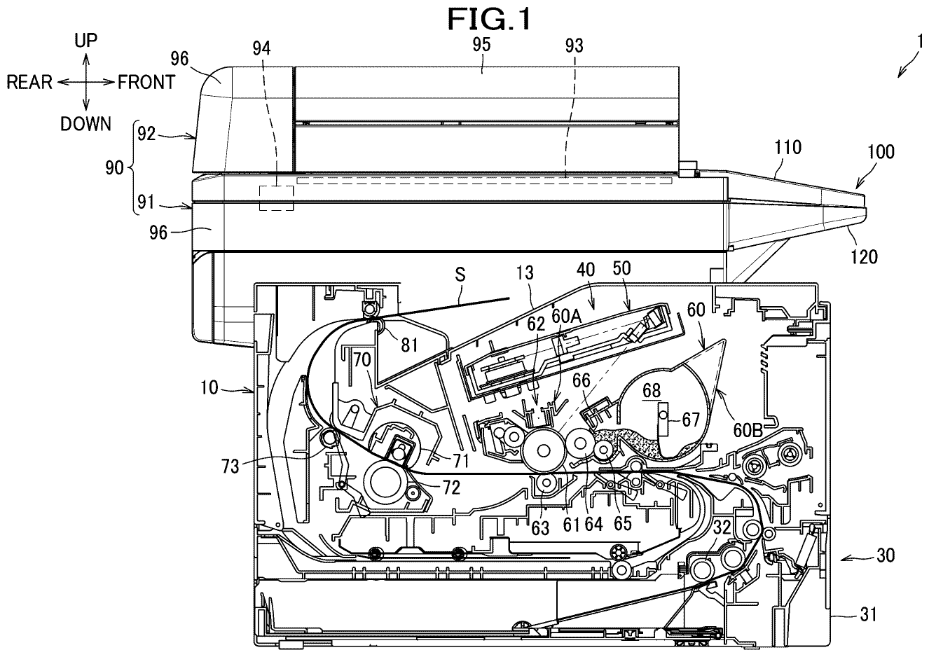

In the following description, directions will be described referring to directions shown in FIG. 1. The right side in FIG. 1 will be referred to as “front”, and the left side of FIG. 1 will be referred to as “rear”. The direction into the sheet of FIG. 1 will be referred to as “right”, and the direction out of the sheet of FIG. 1 will be referred to as “left”. “Upward” and “downward” in FIG. 1 will be referred to as “up (upward)” and “down (downward)”.

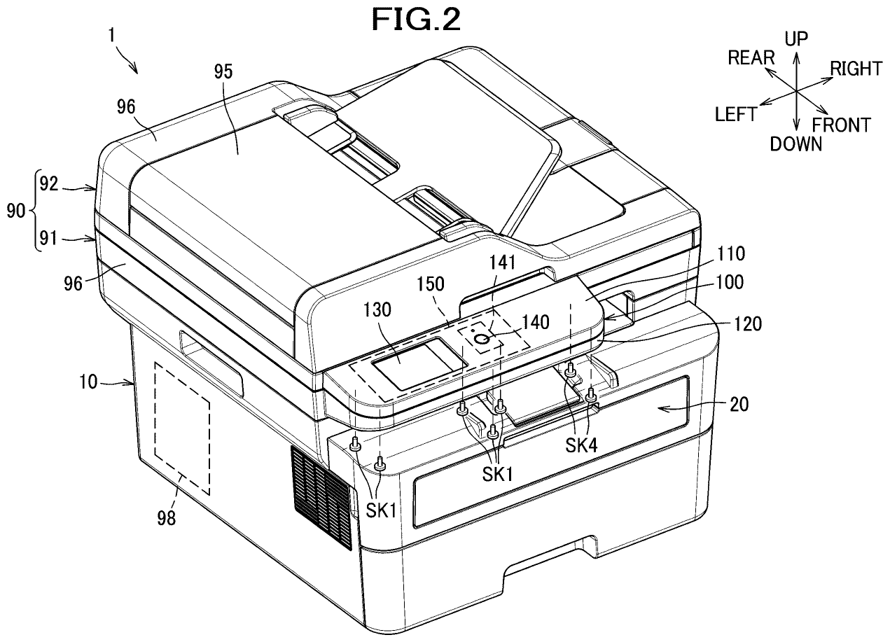

Referring now to FIG. 1, an image forming apparatus 1 is shown, which is an apparatus for forming an image. In this embodiment, the image forming apparatus 1 is a multifunction machine configured to form monochrome images and to make copies. The image forming apparatus 1 comprises a main housing 10, a sheet feeder unit 30, an image forming unit 40, a scanner 90, a main circuit board 98 (see FIG. 2), and an operation panel 100.

The sheet feeder unit 30 comprises a sheet tray 31 and a sheet feeder roller 32. The sheet tray 31 contains sheets S of paper or the like. The sheet feeder roller 32 feeds the sheets S in the sheet tray 31 to the image forming unit 40.

The image forming unit 40 forms an image on each sheet S. The image forming unit 40 comprises an exposure device 50, a process cartridge 60, and a fixing device 70. The exposure device 50, the process cartridge 60, and the fixing device 70 are located in the main housing 10.

The exposure device 50 comprises a light source, a reflector, a lens, a mirror, etc. The exposure device 50 emits a light beam shown by a dashed-double dotted line to expose a surface of a photosensitive drum 61.

The process cartridge 60 comprises a drum cartridge 60A and a development cartridge 60B.

The drum cartridge 60A comprises a photosensitive drum 61, a charger 62, and a transfer roller 63. A toner image is formed on a surface of the photosensitive drum 61.

The development cartridge 60B is installable into and removable from the drum cartridge 60A. The development cartridge 60B comprises a development roller 64, a supply roller 65, a doctor blade 66, an agitator 67, and a toner containing unit 68.

The toner containing unit 68 contains toner. The agitator 67 agitates toner in the toner containing unit 68. The agitator 67 supplies toner to the supply roller 65. The supply roller 65 supplies toner to the development roller 64. The doctor blade 66 contacts a surface of the development roller 64 to adjust the thickness of toner on the development roller 64 to a uniform thickness.

The fixing device 70 comprises a heating unit 71, a pressure roller 72, and an intermediate ejection roller 73. The heating unit 71 comprises a heater, a fixing belt, a nipping plate, etc. The heating unit 71 heats the sheet S. The pressure roller 72 presses the sheet S against the heating unit 71.

The charger 62 charges the surface of the photosensitive drum 61. The exposure device 50 emits a light beam on the surface of the photosensitive drum 61 to thereby form an electrostatic latent image on the photosensitive drum 61 based on image data. The development roller 64 supplies toner to the exposed surface of the photosensitive drum 61. A toner image is thereby formed on the photosensitive drum 61.

The transfer roller 63 conveys the sheet S fed from the sheet feeder unit 30 through between the photosensitive drum 61 and the transfer roller 63 to thereby transfer the toner image formed on the photosensitive drum 61 onto the sheet S.

The fixing device 70 conveys the sheet S on which the toner image is transferred through between the heating unit 71 and the pressure roller 72 to thereby fix the transferred toner image on the sheet S.

The intermediate ejection roller 73 conveys the sheet S on which the toner image is fixed toward an ejection roller 81. The ejection roller 81 ejects the sheet S on which the image is formed onto an ejection tray 13.

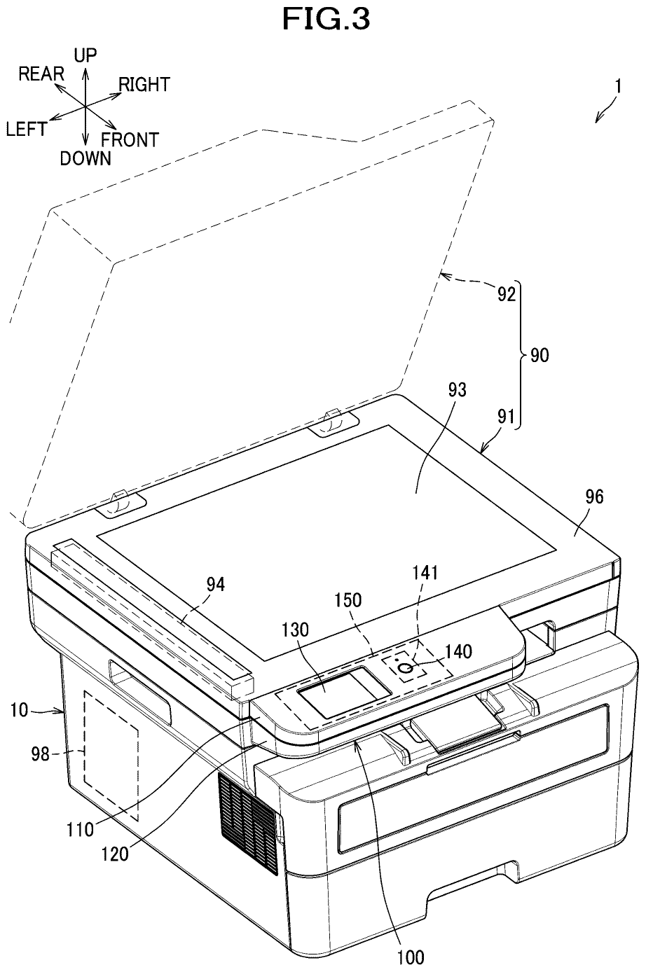

The scanner 90 is capable of scanning a document. The scanner 90 comprises a document holder 91 and a document cover 92. A document is placed on the document holder 91. The document cover 92 is movable relative to the document holder 91 between a hold-down position shown in FIG. 2 and an open position shown in FIG. 3. As shown in FIGS. 2 and 3, the document cover 92 is rotatable relative to the document holder 91. The hold-down position is a position in which the document placed on the document holder 91 is held down. The open position is a position in which an upper surface of the document holder 91 is accessible for placing a document.

Referring back to FIG. 1, the document holder 91 comprises a sheet of glass 93, a sensor unit 94, and a scanner housing 96.

The sensor unit 94 is movable relative to the main housing 10. In more detail, the sensor unit 94 is linearly movable in the horizontal direction relative to the main housing 10. The sensor unit 94 moves relative to the main housing 10 and thereby scans an image of the document placed on the sheet of glass 93. The scanner housing 96 forms an external aesthetic surface of the scanner 90. The scanner housing 96 constitutes a part of the main housing 10.

The document cover 92 comprises an auto document feeder (ADF) 95. The ADF 95 allows documents to be loaded thereon and conveys the documents. Images on the conveyed documents are scanned by the sensor unit 94.

In this embodiment, the scanner housing 96 includes a housing containing the sheet of glass 93 and the sensor unit 94, and a housing of the ADF 95.

As shown in FIG. 2, the main circuit board 98 is disposed in the main housing 10. The main circuit board 98 controls the image forming unit 40 and other components of the image forming apparatus 1.

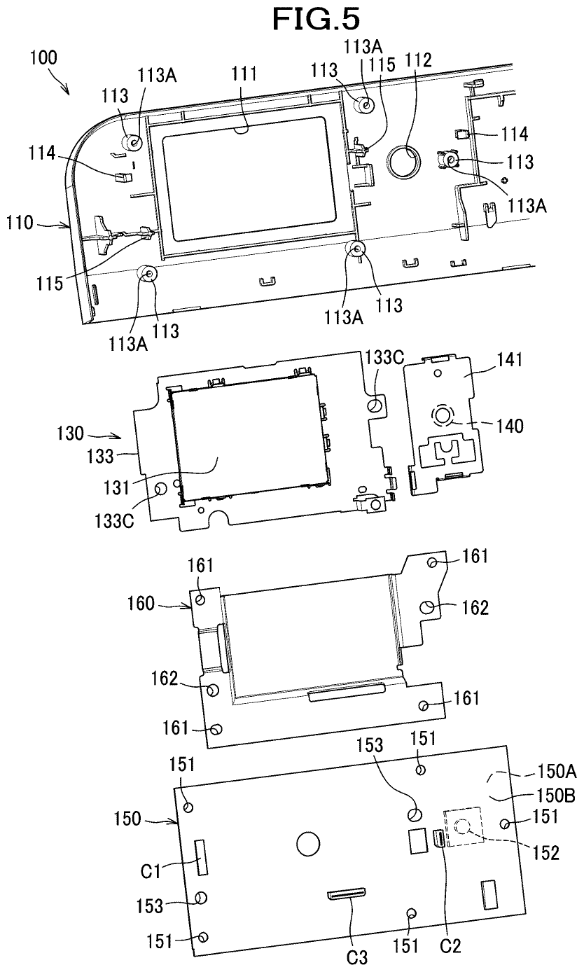

The operation panel 100 is disposed at a front upper portion of the main housing 10. The operation panel 100 comprises a first cover 110, a touch panel 130, a pushbutton panel 140, a panel circuit board 150, and a supporting plate 160 shown in FIG. 5.

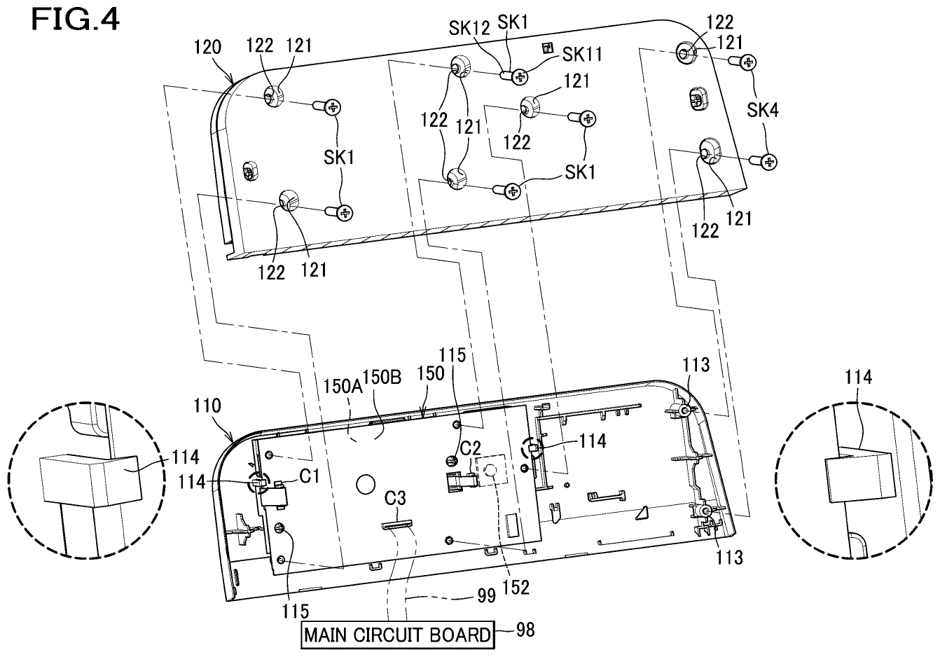

As shown in FIG. 4, the panel circuit board 150 is a circuit board having functions of receiving commands entered via the operation panel 100 and transmitting the entered commands to the main circuit board 98. The panel circuit board 150 is shaped as a rectangular plate. The panel circuit board 150 has a first surface 150A facing the touch panel 130 and a second surface 150B on an opposite face of the panel circuit board 150 from the first surface 150A.

As shown in FIG. 2, the first cover 110 constitutes an upper portion of the operation panel 100. The first cover 110 covers the first surface 150A of the panel circuit board 150, along with the touch panel 130 and the pushbutton panel 140, from a side on which the touch panel 130 and the pushbutton panel 140 are disposed. In this embodiment, the first cover 110 covers the panel circuit board 150, along with the touch panel 130 and the pushbutton panel 140, from above.

The touch panel 130 is an example of a panel that displays information related to image forming. The touch panel 130 and the pushbutton panel 140 are examples of panels that allow input of commands related to image forming.

The scanner housing 96 comprises a second cover 120 protruding horizontally. In this embodiment, the second cover 120 protrudes frontward. The second cover 120 is integrally formed with the scanner housing 96. The second cover 120 covers the second surface 150B of the panel circuit board 150 from a side opposite to a side on which the first cover 110 is located. In the following description, the side on which the first cover 110 is located is referred to as “first-cover side” and the side on which the second cover 120 is located is referred to as “second-cover side”.

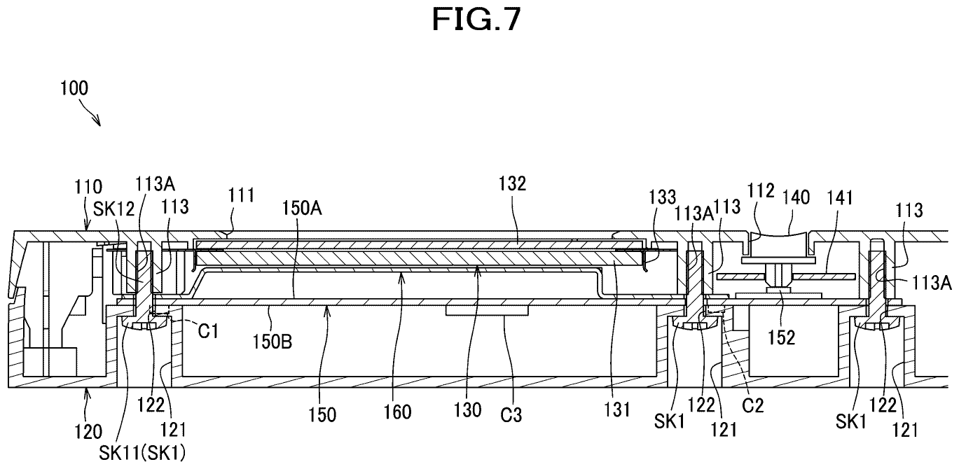

As shown in FIGS. 4 and 7, the first cover 110 and the second cover 120 are fastened to each other by a first fastener SK1 and a fourth fastener SK4. The first fastener SK1 and the fourth fastener SK4 are screws each having a head and a threaded portion. The first fastener SK1 has a head SK11 and a threaded portion SK12. The first fastener SK1 and the fourth fastener SK4 fasten the first cover 110 and the second cover 120 from a second-cover 120 side. A plurality of the first fasteners SK1 and a plurality of the fourth fasteners SK4 are provided. Specifically, the first cover 110 and the second cover 120 are fastened to each other by five first fasteners SK1 and two fourth fasteners SK4.

The first cover 110 is shaped as a rectangular plate. As shown in FIG. 5, the first cover 110 has a panel opening 111, a button window 112, a boss 113, a hook 114, and a locating boss 115.

The panel opening 111 is an opening through which the touch panel 130 is exposed when the touch panel 130 is attached to the first cover 110. The panel opening 111 has a rectangular shape. The touch panel 130 is visible to and touchable by the user through the panel opening 111.

The button window 112 is a hole through which the pushbutton panel 140 is exposed. The button window 112 has a circular shape.

The boss 113 protrudes toward the second cover 120. The boss 113 has a hole 113A into which a corresponding first fastener SK1 is inserted. The first fastener SK1 is screwed into the boss 113. A plurality of the bosses 113 are provided on the first cover 110 and are disposed such that each of the bosses 113 corresponds to one of the first fasteners SK1.

Two hooks 114 are provided on the first cover 110 at positions corresponding to both ends of the panel circuit board 150 in the horizontal direction. The hooks 114 protrude toward the second cover 120 and each have a tab shaped such that the panel circuit board 150 is hooked thereon. The hooks 114 hold the lateral ends of the panel circuit board 150. The hooks 114 hold the panel circuit board 150 such that the panel circuit board 150 does not fall off the first cover 110 when the first cover 110 is removed from the second cover.

The locating boss 115 is shaped as a cross and protrudes toward the second cover 120. The locating boss 115 locates the touch panel 130 in place on the first cover 110. One locating boss 115 is provided on each lateral side of the panel opening 111.

As shown in FIG. 4, the second cover 120 is shaped as a rectangular plate elongated in the horizontal direction. The second cover 120 has a recess 121 and a through hole 122. In this embodiment, the second cover 120 has a plurality of the recesses 121 and a plurality of the through holes 122.

The recesses 121 are formed in a surface of second cover 120 opposite to a surface facing the panel circuit board 150. Each recess 121 is a hole into which the head SK11 of the corresponding first fastener SK1 is inserted. The recess 121 is a hole with a bottom. The diameter of the recess 121 is larger than the diameter of the head SK11 of the first fastener SK1.

Each through hole 122 is a hole through which the threaded portion SK12 of the corresponding first fastener SK1 extends. The through hole 122 is disposed over the hole 113A of a corresponding boss 113. The through hole 122 is formed in a central portion of the bottom of the corresponding recess 121. The diameter of the through hole 122 is smaller than the diameter of the head SK11 of the first fastener SK1.

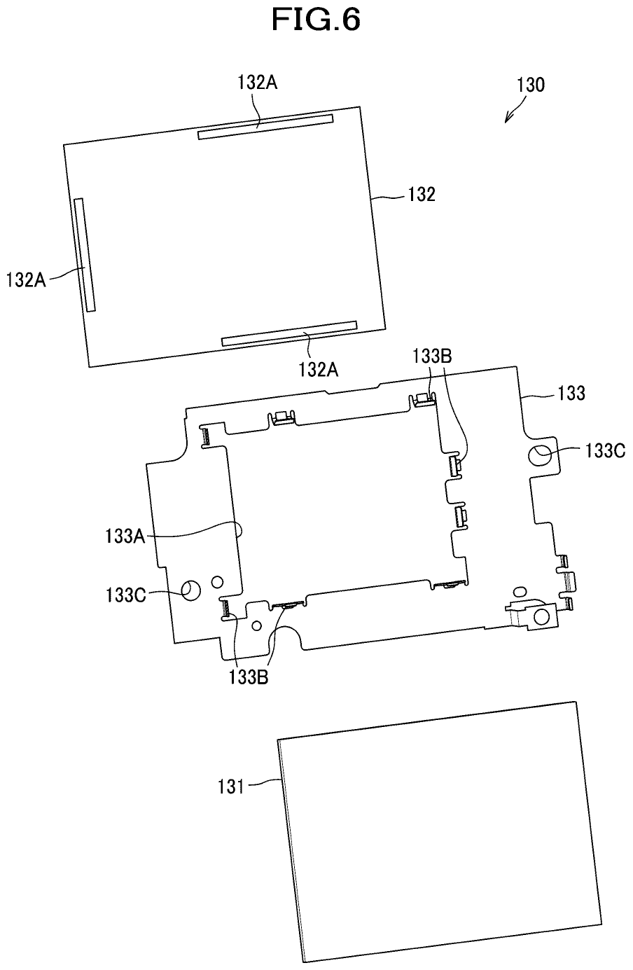

As shown in FIG. 6, the touch panel 130 comprises a liquid crystal panel 131, a sensing panel 132, and a touch panel plate 133.

The liquid crystal panel 131 is shaped as a rectangular plate. The liquid crystal panel 131 is positioned beneath the sensing panel 132. The liquid crystal panel 131 is configured to display information related to image forming and images such as buttons for allowing input of commands. The liquid crystal panel 131 is held by the touch panel plate 133.

The sensing panel 132 is shaped as a rectangular plate. The sensing panel 132 is positioned above the liquid crystal panel 131. The sensing panel 132 is configured to sense contact and allow input of commands. The sensing panel 132 is fixed to the touch panel plate 133 by double sided tape 132A.

The touch panel plate 133 is located between the liquid crystal panel 131 and the sensing panel 132. The touch panel plate 133 is made of sheet metal. The touch panel plate 133 has a liquid crystal window 133A, a liquid crystal holding portion 133B, and a locating hole 133C. The liquid crystal window 133A is an opening through which the display surface of the liquid crystal panel 131 is exposed. A plurality of the liquid crystal holding portions 133B are provided at the edges of the liquid crystal window 133A to hold the liquid crystal panel 131. Two locating holes 133C are formed in the touch panel plate 133 at positions each corresponding to one of the two locating bosses 115. The locating holes 133C are engaged with the locating bosses 115 to locate the touch panel plate 133 on the first cover 110

The touch panel plate 133 holds the liquid crystal panel 131 and the sensing panel 132 and ensures the overall rigidity of the liquid crystal panel 131 and the sensing panel 132.

As shown in FIG. 5, the panel circuit board 150 has a circuit board fastening hole 151, a pushbutton switch 152, a locating hole 153, a first connector C1, a second connector C2, and a third connector C3. A plurality of the circuit board fastening holes 151 are formed in the panel circuit board 150. In this embodiment, five circuit board fastening holes 151 are formed in the panel circuit board 150. Each of the circuit board fastening holes 151 is a hole through which the corresponding first fastener SK1, which fastens the panel circuit board 150 to the first cover 110, extends.

The pushbutton switch 152 is, for example, a switch for the main power supply. The pushbutton switch 152 is located on the first surface 150A of the panel circuit board 150.

Two locating holes 153 are formed in the panel circuit board 150 at positions each corresponding to one of the two locating bosses 115. The locating holes 153 are engaged with the locating bosses 115 to locate the panel circuit board 150 on the first cover 110.

The first connector C1, the second connector C2, and the third connector C3 are disposed on the second surface 150B. The first connector C1 is a connector to which a harness extending from the liquid crystal panel 131 is connected. The second connector C2 is a connector to which a harness extending from the sensing panel 132 is connected. The panel circuit board 150 is electrically connected with the touch panel 130 by the first connector C1 and the second connector C2. As shown in FIG. 4, the third connector C3 is electrically connected with the main circuit board 98 by a cable 99 of the image forming apparatus 1.

As shown in FIGS. 5 and 7, the pushbutton panel 140 is placed on top of the pushbutton switch 152. The pushbutton panel 140 is held by the first cover 110 via the button plate 141 in a manner that allows the pushbutton panel 140 to move upward and downward relative to the first cover 110. The pushbutton panel 140 is exposed through the button window 112 of the first cover 110. Pushing the pushbutton panel 140 causes the pushbutton switch 152 to be pushed down. In other words, commands are input to the panel circuit board 150 via the pushbutton panel 140.

The supporting plate 160 is formed from sheet metal. The supporting plate 160 supports the touch panel 130 and ensures the rigidity of the touch panel 130. The supporting plate 160 is located between the touch panel 130 and the panel circuit board 150. The supporting plate 160 is located beneath the touch panel 130. When the touch panel 130 is pushed from above to operate the touch panel 130, the supporting plate 160 supports the touch panel from below. The supporting plate 160 has a panel fastening hole 161 and a locating hole 162.

A plurality of the panel fastening holes 161 are formed in the supporting plate 160. In this embodiment, four panel fastening holes 161 are formed in the supporting plate 160. Each of the panel fastening holes 161 is formed in a position corresponding to the hole 113A of one of the bosses 113.

Two locating holes 162 are formed in the supporting panel 160 at positions each corresponding to one of the two locating bosses 115. The locating holes 162 are engaged with the corresponding locating bosses 115 to locate the supporting plate 160 in place on the first cover 110.

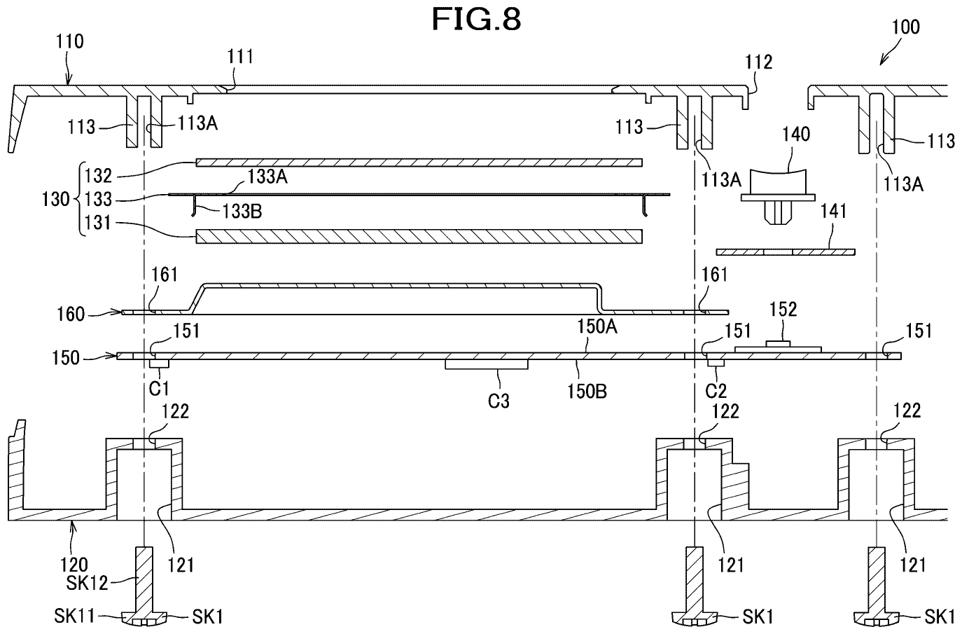

As shown in FIGS. 5 and 7, the touch panel 130 and the supporting plate 160 are attached to the first cover 110 in such a manner that the locating bosses 115 are inserted into the corresponding locating holes 133C and the corresponding locating holes 162. The panel circuit board 150 is attached to the first cover 110 in such a manner that the locating bosses 115 are inserted into the corresponding locating holes 153. When the panel circuit board 150 is attached to the first cover 110, the hooks 114 are hooked onto the panel circuit board 150. The touch panel 130, the supporting plate 160, and the panel circuit board 150 are thereby fixed to the first cover 110 and kept from falling off the first cover 110. As shown in FIG. 8, the threaded portion SK12 of each of the first fasteners SK1 is inserted into the corresponding one of the through holes 122 of the second cover 120, the corresponding one of the circuit board fastening holes 151, the corresponding one of the panel fastening holes 161, and is screwed into the hole 113A of the corresponding one of the bosses 113 to thereby screw the second cover 120, the touch panel 130, the supporting plate 160, and the panel circuit board 150 on the first cover 110 together.

The panel circuit board 150 is fastened to the first cover 110 and the second cover 120 by the first fasteners SK1, i.e., without any fastening members other than the first fasteners SK1. Further, the supporting plate 160 is fastened to the first cover 110 and the second cover 120 by the first fasteners SK1, i.e., without any fastening members other than the first fasteners SK1. The fourth fasteners SK4 fasten the first cover 110 and the second cover 120, but do not fasten the panel circuit board 150 together with the first cover 110 and the second cover 120. Thus, by removing the first fasteners SK1 and the fourth fasteners SK4 and removing the first cover 110 from the second cover 120, the panel circuit board 150 and the supporting plate 160 can be removed from the first cover 110 without removing any other fasteners.

Next, the process of replacing the touch panel 130, the pushbutton panel 140, and the panel circuit board 150 will be described.

As shown in FIG. 2, in order to remove the touch panel 130, the pushbutton panel 140, or the panel circuit board 150 for replacement, the first fasteners SK1 and the fourth fasteners SK4 are removed from the operation panel 100 at the outset.

As shown in FIG. 4, after the first fasteners SK1 and the fourth fasteners SK4 are removed, the first cover 110 can be removed from the second cover 120.

When the first cover 110 is removed from the second cover 120, the panel circuit board 150, which is held by the first cover 110, becomes accessible. At this time, the panel circuit board 150, which is held on the first cover 110 by the hooks 114, will not fall off the first cover 110.

Next, the harnesses are pulled out of the first connector C1, the second connector C2, and the third connector C3.

The panel circuit board 150 is then removed from the first cover 110 by causing the tabs of the hooks 114 holding the panel circuit board 150 to deform.

In the case the touch panel 130 is to be removed, the supporting plate 160 is removed and then the touch panel 130 is removed from the first cover 110.

In the case the pushbutton panel 140 is to be removed, the button plate 141 is removed, and then the pushbutton panel 140 can be easily removed from the first cover 110.

Next, the process of attaching the touch panel 130 and the pushbutton panel 140 will be described. First, the touch panel 130, the supporting plate 160, and the pushbutton panel 140 are attached to the first cover 110.

The panel circuit board 150 is then attached to the first cover 110 in such a manner that the panel circuit board 150 overlaps the supporting plate 160 and the pushbutton panel 140. At this time, the panel circuit board 150 is engaged with the hooks 114. Once the panel circuit board 150 is engaged with the hooks 114, the panel circuit board 150 is held by the first cover 110 and will not fall off the first cover 110.

Subsequently, the harness extending from the liquid crystal panel 131 is connected to the first connector C1. The harness extending from the sensing panel 132 is connected to the second connector C2. Further, the harness extending from the main circuit board 98 is connected to the third connector C3.

As shown in FIG. 2, the first cover 110 and the second cover 120 are then fastened to each other by the first fasteners SK1 and the fourth fasteners SK4. At this time, as shown in FIG. 7, the second cover 120, the touch panel 130, the supporting plate 160, and the panel circuit board 150 are fastened together by the first fasteners SK1.

The following advantageous effects can be achieved according to the above-described embodiment.

In an image forming apparatus known in the art, when a panel circuit board is replaced, fasteners fixing a cover are removed and then fasteners fastening a panel to the cover are removed. Thus, many fasteners have to be removed.

However, the above-described image forming device 1 comprises first fasteners SK1 that fasten the first cover 110, the panel circuit board 150, and the second cover 120 together. Thus, the panel circuit board 150 can be easily replaced by removing the first fasteners SK1, without removing many fasteners.

The first fasteners SK1 are fastened from the second-cover 120 side; thus, the first fasteners SK1 are not easily noticeable from the first-cover 110 side. In this embodiment, the second cover 120 is located under the first cover 110; thus, the first fasteners SK1 are not visible from above and are not easily noticeable.

The heads SK11 of the first fasteners SK1 are located in the recesses 121 of the cover 120. Thus, the heads SK11 of the first fasteners SK1 can be made less noticeable.

The second cover 120 is integrally formed with the scanner housing 96; thus, the rigidity of the second cover 120 can be ensured.

The first cover 110 has hooks 114 that hold the panel circuit board 150. Thus, the panel circuit board 150 does not fall off the first cover 110 even if the first fasteners SK1 are removed. The operator can easily remove the panel circuit board 150 from the first cover 110 by disengaging the hooks 114.

The third connector C3 to which the cable 99, which electrically connects the main circuit board 98 and the panel circuit board 150, is connected is located on the second surface 150B of the panel circuit board 150. Thus, the cable 99 is easily removable when the panel circuit board 150 is to be replaced.

The panel circuit board 150 is fastened to the first cover 110 and the second cover 120 without any fastening members other than the first fasteners SK1; thus, the panel circuit board 150 can be removed if the first fasteners SK1 are removed.

The supporting plate 160 is fastened to the first cover 110 and the second cover 120 without any fastening members other than the first fasteners SK1; thus, the supporting plate 160 can be removed if the first fasteners SK1 are removed.

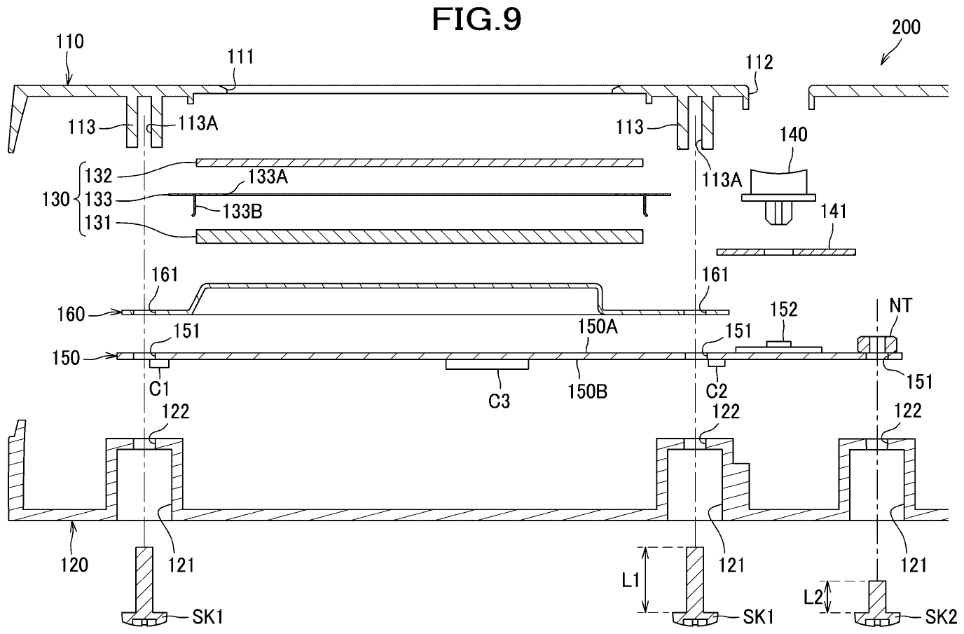

Next, a second embodiment of the present disclosure will be described in detail referring to FIG. 9. In the following description, the same reference numerals as the above-described embodiment are used to identify components similar to those of the above-described embodiment and detailed description of such components will be omitted.

As shown in FIG. 9, an operation panel 200 according to the second embodiment comprises a second fastener SK2 that fastens the second cover 120 and the panel circuit board 150. The second fastener SK2 is a screw. The length L2 of the second fastener SK2 is shorter than the length L1 of the first fastener SK1. The panel circuit board 150 comprises a nut NT. The second fastener SK2 extends through the through hole 122 of the second cover 120 and the circuit board fastening hole 151 and is screwed into the nut NT. In this way, the second fastener SK2 fastens the second cover 120 and the panel circuit board 150. It is to be noted that the second fastener SK2 does not fasten the panel circuit board 150 to the first cover 110.

The second fastener SK2 fastens the second cover 120 and the panel circuit board 150 and does not fasten the panel circuit board 150 to the first cover 110. Thus, by removing the first fasteners SK1 and not removing the second fastener SK2, the first cover 110 can be removed from the second cover 120 while the panel circuit board 150 remains fastened to the second cover. In this state, the touch panel 130 can be removed from the first cover 110 and be replaced.

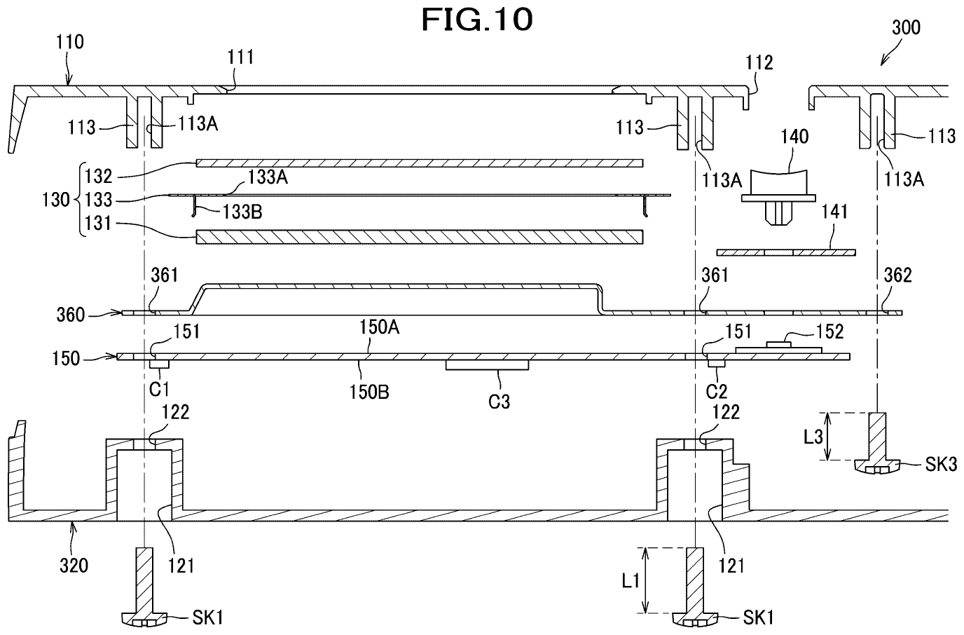

Next, a third embodiment of the present disclosure will be described in detail referring to FIG. 10.

As shown in FIG. 10, an operation panel 300 according to the third embodiment comprises a third fastener SK3 that fastens the first cover 110 and a supporting plate 360, but does not fasten the second cover 320 and the panel circuit board 150. The third fastener SK3 is a screw. The length L3 of the third fastener SK3 is shorter than the length L1 of the first fastener SK1.

The supporting plate 360 in this embodiment has panel fastening holes 361 through which the corresponding first fasteners SK1 extend and a panel fastening hole 362 through which the third fastener SK3 extends.

The third fastener SK3 extends through the panel fastening hole 362 of the supporting plate 360 and is screwed into the boss 113 of the first cover 110. In this way, the third fastener SK3 fastens the first cover 110 and the supporting plate 360. It is to be noted that the third fastener SK3 does not fasten the panel circuit board 150 and the second cover 320 to the first cover 110.

The third fastener SK3 fastens the first cover 110 and the supporting plate 360 and does not fasten the panel circuit board 150 and the second cover 320 to the first cover 110; thus, by removing the first fasteners SK1 and not removing the third fastener SK3, the panel circuit board 150 can be replaced while the supporting plate 360 remains fastened to the first cover 110.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:
In the above-described embodiments, another component may be disposed between the panel circuit board 150 and the second cover 120.

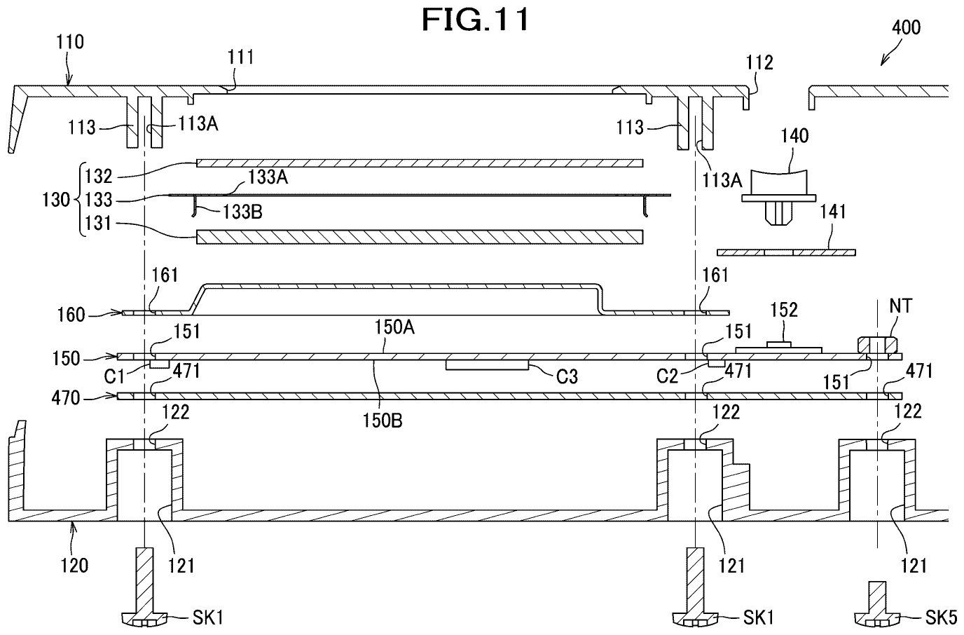

For example, an operation panel 400 shown in FIG. 11 further comprises a metal plate 470. The metal plate 470 is located between the panel circuit board 150 and the second cover 120. The metal plate 470 is grounded by a grounding member not shown in the drawings. The metal plate 470 has plate fixing holes 471. The fifth fastener SK5 extends through one of the plate fixing holes 471. The panel circuit board 150 comprises a nut NT. The fifth fastener SK5 extends through the through hole 122 of the second cover 120, the plate fixing hole 471 of the metal plate 470, and the circuit board fastening hole 151 and is screwed into the nut NT.

Since the metal plate 470, which is fastened by the fifth fastener SK5 together with the panel circuit board 150 and the second cover 120, is further included in this configuration, static electricity is reduced or prevented from building up in the panel circuit board 150 and the second cover 120.

In the above-described embodiments, the first cover 110 may be configured to move rotatably relative to the second cover 120.

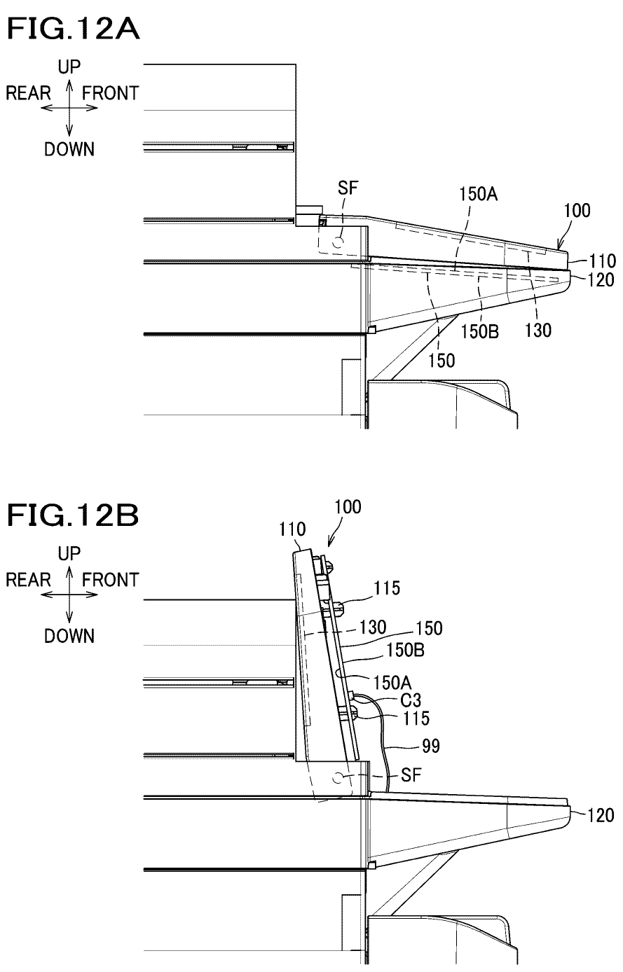

For example, the configuration shown in FIGS. 12A and 12B further comprises a shaft SF that rotatably supports the first cover 110 relative to the second cover 120. The first cover 110 is rotatable between an open position shown in FIG. 12B in which the second surface 150B is accessible for replacement, and a closed position shown in FIG. 12A in which the second surface 150B is not accessible.

Since the first cover 110 is rotatable to an open position in which the second surface 150B of the panel circuit board 150 is accessible in the configuration shown in FIG. 12, the panel circuit board 150 can be removed in a state where the first cover 110 is located in the open position. Removal of the panel circuit board 150 in a state where the first cover 110 is located in the open position makes it easier to remove the panel circuit board 150.

Although, the touch panel 130 and the pushbutton panel 140 are given as examples of panels on which information related to image forming is displayable or into which commands related to image forming are inputtable in the above-described embodiments, the present disclosure is not limited to such configuration.

For example, the panel may only comprise the touch panel 130.

For example, the panel may only comprise the pushbutton panel 140.

For example, the panel may only comprise the liquid crystal panel 131, i.e., the panel may only have a function of displaying information related to image forming.

Although the image forming apparatus is configured such that the first fasteners SK1 fasten the first cover 110 and the second cover 120 from the second-cover 120 side in the above-described embodiments, the image forming apparatus may be configured such that the first fasteners SK1 fasten the first cover 110 and the second cover 120 from the first-cover 110 side.

Although the first fasteners SK1, the second fastener SK2, the third fastener SK3, the fourth fasteners SK4, and the fifth fastener SK5 are screws in the above-described embodiments, the fasteners may be fasteners other than screws. For example, the fasteners may be rivets or fastening pins.

Although the first cover 110 and the second cover 120 are fastened to each other by five first fasteners SK1 and two fourth fasteners SK4 in the above-described first embodiment, the number of the first fasteners SK1 and the fourth fasteners SK4 may be determined arbitrarily.

Another component may be provided between the touch panel 130 and the supporting plate 160. That is, the supporting plate 160 may support the touch panel 130 indirectly via another component

Although the image forming device 1 is a multifunction machine capable of forming monochrome images and capable of making copies in the above-described embodiments, the image forming apparatus may be, for example, capable of forming multi-color images. The image forming device may be a printer or a copying machine. The image forming apparatus may not only be an electrophotographic image forming apparatus but may also be an ink-jet image forming apparatus.

The elements described in the above embodiments and its modified examples may be implemented selectively and in combination.

What is claimed is

1. An image forming apparatus comprising:
a panel;
a panel circuit board having a first surface and a second surface on opposite faces of the panel circuit board, the panel being located on the first surface;
a first cover facing the first surface of the panel circuit board, the first cover having a panel opening;
a second cover facing the second surface of the panel circuit board; and
a first fastener fastening the first cover, the panel circuit board, and the second cover together,
wherein the first cover includes a hook for holding the panel circuit board.

2. The image forming apparatus according to claim 1, wherein the first fastener fastens the first cover and the second cover from a second-cover side.

3. The image forming apparatus according to claim 1, wherein the first cover has a boss protruding toward the second cover, the boss having a hole into which the first fastener is inserted.

4. The image forming apparatus according to claim 3, wherein
the first fastener is a screw including a threaded portion and a head, and
the second cover includes:
a recess into which the head of the first fastener is inserted; and
a through hole through which the threaded portion of the first fastener extends, the through hole being located in a position that overlaps the hole of the boss.

5. The image forming apparatus according to claim 1, further comprising:
a main housing;
an image forming unit configured to form an image on the sheet;
a scanner configured to scan a document; and
a scanner housing forming an external aesthetic surface of the scanner, the scanner housing constituting a part of the main housing;
wherein the scanner housing includes the second cover.

6. The image forming apparatus according to claim 5, wherein the second cover is integrally formed with the scanner housing and protrudes horizontally.

7. The image forming apparatus according to claim 1, further comprising another first fastener,
wherein each of the first fasteners fastens the first cover, the panel circuit board, and the second cover together.

8. The image forming apparatus according to claim 1, further comprising:
an image forming unit;
a main circuit board configured to control the image forming unit; and
a cable configured to electrically connect the main circuit board and the panel circuit board,
wherein the panel circuit board comprises a connector to which the cable is connected, and
wherein the connector is located on the second surface of the panel circuit board.

9. The image forming apparatus according to claim 1, wherein the panel circuit board is connected to the first cover and the second cover by the first fastener without any fastening members.

10. The image forming apparatus according to claim 1, further comprising a metal plate located between the panel circuit board and the second cover, the metal plate being fastened by the first fastener together with the panel circuit board and the second cover.

11. The image forming apparatus according to claim 1, further comprising a second fastener configured to fasten the second cover and the panel circuit board and not to fasten the panel circuit board to the first cover.

12. The image forming apparatus according to claim 11, wherein
the first fastener and the second fastener are screws, and
the second fastener is shorter than the first fastener.

13. The image forming apparatus according to claim 1, further comprising a shaft that rotatably supports the first cover relative to the second cover,
wherein the first cover is rotatable between an open position in which the second surface of the panel circuit board is accessible and a closed position in which the second surface of the panel circuit board is not accessible.

14. The image forming apparatus according to claim 1, further comprising a supporting plate configured to support the panel, the supporting plate being located between the panel and the panel circuit board and being fastened by the first fastener together with the first cover, the panel circuit board, and the second cover.

15. The image forming apparatus according to claim 14, wherein the panel circuit board is in contact with the supporting plate.

16. The image forming apparatus according to claim 14, further comprising a third fastener configured to fasten the first cover and the supporting plate and not to fasten the panel circuit board and the second cover to the first cover.

17. The image forming apparatus according to claim 16, wherein
the first fastener and the third fastener are screws, and
the third fastener is shorter than the first fastener.

18. The image forming apparatus according to claim 14, wherein
the panel comprises:
a sensing panel configured to sense contact;
a liquid crystal panel positioned beneath the sensing panel; and
a touch panel plate positioned between the sensing panel and the liquid crystal panel,
the liquid crystal panel is located between the touch panel plate and the supporting plate.

19. The image forming apparatus according to claim 14, wherein the supporting plate is fastened to the first cover and the second cover by the first fastener without any fastening members.
